(19) United States
(12) Patent Application Publication
(10) Pub. No.: US 2024/0255717 A1
(43) Pub. Date: Aug. 1, 2024

(54) Aerial Optical Fiber Cable

(71) Applicant: HFCL Limited, New Delhi (IN)

(72) Inventors: Pramod Agarwal, Telengana (IN); Jyoti Prakash Das, Telengana (IN); Manohar Pol, Telengana (IN); Peter Weimann, Atlanta, GA (US)

(73) Assignee: HFCL Limited, New Delhi (IN)

(21) Appl. No.: 18/634,271

(22) Filed: Apr. 12, 2024

Related U.S. Application Data
(63) Continuation of application No. PCT/IN2023/050645, filed on Jul. 3, 2023.

(30) Foreign Application Priority Data
Nov. 29, 2022 (IN) 202211068709

(51) Int. Cl. G02B 6/44

(52) U.S. Cl. CPC G02B 6/4432; G02B 6/44384

(57) ABSTRACT

An optical fiber cable [100] is disclosed that is capable of aerial suspension. The optical fiber cable [100] comprises at least one substantially round, flexible outer sheath [102]; at least one easily peelable color coded sleeves [106] enclosing plurality of fibers [104]; and at least one strength member [108] suspended linear to an axis of the fiber optical cable [100] and surrounded with an anti-corrosion coating, wherein the optical fiber cable [100] has breaking strength between 1300 and 2000 N.

### RELATED APPLICATIONS

This application is a continuation patent application of PCT International Patent Application No. PCT/IN2023/050645, filed Jul. 3, 2023, which claims the benefit of and priority to IN Application No. 202211068709, filed on Nov. 29, 2022, the contents of each of which are incorporated herein by reference in their entireties.

### TECHNICAL FIELD

The present invention generally relates to optical fiber cables. In particular, the present disclosure relates to aerial optical fiber cable with minimal diameter and optimized tensile strength.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

As a result of the rapid transformation of telecommunications services, which has increased the volume of data transmission and higher bandwidth requirements, it has become necessary to increase the fiber count in the cables beyond 48 fibers to 72, 96 or even higher fibers in order to support next-generation services such as FTTH and 5G mobility and to provide better connectivity between infrastructures quickly and affordably. It is common to lay these cables aerially, leveraging existing poles for deployment of optical fiber. However, cables that are suspended in the air are susceptible to external threats like road accidents, falling trees, ice storms or high winds, etc. In such circumstances, optical cables must be engineered to cause minimal infrastructure damage, no human casualties, and minimal external impact damage. High tensile strength and crush resistance of cable can prevent cable breakage in these conditions, but if the cable failed to break in severe conditions, it could cause the corresponding pole structures to collapse and possibly cause damage to property and threaten the lives of people. Due to the potential risk to life and property, tensile strength is a crucial mechanical characteristic of any aerial cable. However, cables with too low a tensile strength could break too easily, resulting in frequent repairs, which will cost money and cause protracted network outages in the affected area.

Furthermore, in rural areas, suburban areas, and along railroad rights-of-way, the cheapest and most suitable way to deploy optical fiber cable infrastructure to increase the network of telecommunication and connectivity is to install self-supporting aerial cables on existing telephone/telegraph poles. However, large and heavy cables may only be placed after pole inspection, followed by pole reinforcement or replacement.

To achieve an adequate point of breakage and to meet future communication requirements, an optical fiber cable with a high fiber density and optimised tensile strength is required.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

An object of the present invention is to provide a high density optical fiber cable with higher fiber count and reduced outer diameter, which can be suspended aerially and does not require any change to the current infrastructure setting, in order to overcome at least some of the drawbacks mentioned in the previous section and those otherwise known to persons skilled in the art. Another object of the present invention is to provide an optical fiber cable that reduces repair needs and minimizes network outages with corresponding cost benefits. Another object of the present disclosure is to provide an optical fiber cable that has optimized tensile strength sufficient to support short-span installations but that breaks in the event of any unforeseen circumstance to prevent any damage to the infrastructure it has been suspended on. Another object of the present disclosure is to provide an optical fiber cable that has a high optical fiber density.

Furthermore, in order to achieve the aforementioned objectives, the invention provides an optical fiber cable comprising an outer sheath; plurality of easily peelable sleeves enclosing plurality of optical fibers; and at least two strength members suspended linear to an axis of the optical fiber cable, wherein the optical fiber cable has breaking strength between 1300 and 2000 N.

### BRIEF DESCRIPTION OF DRAWINGS

The accompanying drawings, which are incorporated herein, and constitute a part of this disclosure, illustrate exemplary embodiments of the invention in which like reference numerals refer to the same parts throughout the different drawings. Components in the drawings are not necessarily to scale, emphasis instead being placed upon clearly illustrating the principles of the present disclosure.

FIG. 1A is a cross sectional view of the optical fiber cable, in accordance with exemplary embodiments of the present disclosure.

FIG. 1B is a longitudinal sectional view of the optical fiber cable, in accordance with exemplary embodiments of the present disclosure.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As disclosed in the background section, existing technologies have many limitations, and in order to overcome at least some of the limitations of the prior known solutions, the present disclosure provides a nominal diameter and high fiber count optical fiber cable having a break strength in the range of 1300 to 2000 N. Furthermore, a linearly suspended strength member is disclosed, which enables the optical fiber cable to be used in the most efficient manner. The optical fiber cable comprises a substantially round flexible outer sheath, one or more easily peelable sleeve comprising plurality of optical fibers, and one or more linearly suspended strength members.

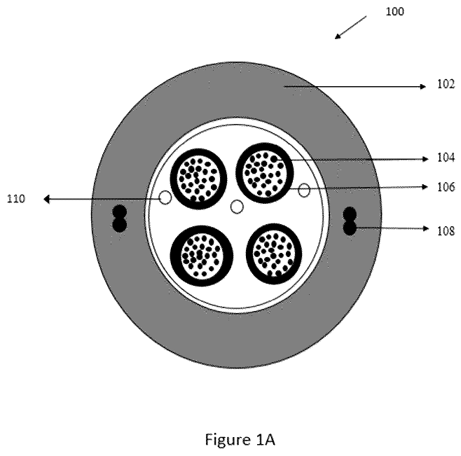

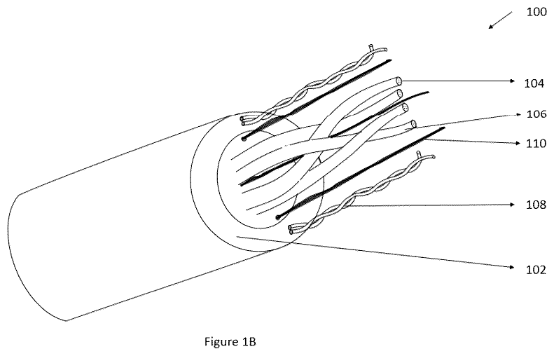

Referring now to FIG. 1A, where a cross sectional view of the optical fiber cable is disclosed, the optical fiber cable (also referred to as optical cable or fiber cable or simply as cable, and all the terms are used interchangeably hereinafter), which has a circular cross section, includes a substantially round, flexible outer sheath [102] enclosing multiple easily peelable sleeves [106] surrounding one or more optical fibers [104]. The outer sheath [102] may be made of polyethylene material such as High Density Polyethylene (HDPE).

For instance, the optical fiber cable [100] may include four easily peelable colour coded sleeves [106], wherein each sleeve comprises 24 fibers each. These easily peelable colour coded sleeves [106] may be twisted/stranded together with either a continuous or reverse oscillating lay twist. The easily peelable sleeves [106] are made of soft material a thermoplastic urethane or a low smoke zero halogen compound that can be easily peeled with bare hand without requiring any tools. The soft material has a hardness less than 60 Shore D. Further, the easily peelable sleeves has, a nominal thickness of 0.2 mm or less. In another embodiment, the easily peelable sleeves has a nominal thickness in range of 0.1 mm to 0.3 mm.

Further, one or more sleeves include water blocking element to prevent ingression of water or moisture within the sleeves. The water blocking element is selected from group including water blocking gel, water-swellable powder, water swellable yarn or tape.

The optical fiber cable [102] also contains at least one water swellable yarns [110] enclosed within the outer sheath [102] to prevent ingression of water or moisture within the cable. In yet another embodiment, the outer sheath [102] encloses one or more water swellable tapes.

Also, the optical fibers [104] have a nominal cladding diameter of 125 um. In an alternate embodiment, optical fibers [104] have a nominal cladding diameter less than 125 um, with a nominal cladding diameter in a preferred embodiment is between 80 and 100 um. Further, the optical fiber cable [100] as disclosed by the present disclosure may include optical fiber cable with 60, 72, 96, 120, 144 and 192 fibers. Furthermore, in an implementation of the present disclosure, optical fiber cable [100] may have more than 192 fibers.

Preferably, the outer diameter of the coated and colored fibers is smaller than 215 um. In a more preferred embodiment, the optical fibers [104] have an outer diameter in the range from 160 to 200 um. In other embodiment optical fibers [104] has outer diameter of 200+/−15 um.

Further, the optical fiber cable [100] includes at least two strength members [108] suspended linear to an axis of the optical fiber cable [100]. These strength members [108] are coated or surrounded with an anti-corrosion layer. The anti-corrosion layer is selected from a group comprising brass, chrome, ethylene-acrylic acid copolymer, propylene-acrylic acid copolymer, and phosphate compounds.

In an exemplary embodiment, the strength members [108] comprise a pair of steel wires stranded together to form the single strength member [108]. In an exemplary implementation of this embodiment, each wire within the pair has an outer diameter of 0.3+/−0.05 mm. In an exemplary embodiment, the strength member [108] has total cross sectional area less than 0.40 mm².

In an embodiment, more than one strength members [108] are embedded in the outer sheath [102]. In a preferred embodiment, two strength members [108] are embedded in the outer sheath [102], and placed diametrically opposite to each other.

The optical fiber cable [100] of the present invention has breaking strength between 1300 and 2000 N and a nominal outer diameter not larger than 7.0 mm. In a preferred embodiment, the nominal outer diameter is around 7.0+/−0.2 mm. Further, the optical fiber cable [100] of the present invention has a nominal weight around 36.0+/−10% Kg/Km.

In an exemplary implementation, a 96 fiber cable encloses four colour-coded easily peelable sleeves [106]. Each sleeve [106] encloses 24 fibers with a nominal cladding diameter of 125 μm and an outer diameter of 200+/−15 um. In another embodiment, the fibers [104] have nominal cladding diameter in range of 80 to 100 um. In an alternate embodiment, the fibers [104] have nominal outer diameter of 160 to 200 um. Further, each fiber [104] within the sleeves [106] are uniquely identifiable by unique colour coating. In case of more than 12 fibers are enclosed within the sleeves [106], ring marking is used over the fibers [104] for unique identification. In an embodiment, single ring-marking is done on natural fibers instead of fibers already colored with a black color or any other color.

The exemplary cable [100] has a fiber strain less than 0.67% at the maximum environmental load of around 950 N and a consistent break strength less than 2000 N. In a preferred embodiment, the exemplary cable [100] has a fiber strain around 0.63% at the maximum environmental load of around 950 N and a consistent break strength around 1850 N.

In another exemplary implementation, a 72 fiber cable encloses three sleeves containing 24 fibers each. In an alternate embodiment, a 72 fiber cable encloses six sleeves containing 12 fibers each. Each fiber has a nominal cladding diameter around 125 um and an outer diameter of 200+/−15 um. In another embodiment, the fibers [104] have nominal cladding diameter in range of 80 to 100 um. In an alternate embodiment, the fibers [104] have nominal outer diameter between 160 to 200 um.

Referring now to FIG. 1B, where a cross-longitudinal view of the optical fiber cable is disclosed. The optical fiber cable [100] (also referred to as optical cable or fiber cable or simply as cable, and all the terms are used interchangeably hereinafter), which has a substantially circular cross section, includes a substantially round, flexible outer sheath [102] enclosing one or more sleeves. The outer sheath [102] may be made of polyethylene material such as HDPE (High-density polyethylene). The outer sheath has a nominal thickness around 1.3 mm.

The optical fibers [104] are surrounded by easily peelable colour coded sleeves [106]. These easily peelable colour coded sleeves [106] are twisted/stranded together with either a continuous or a reverse oscillating lay twist. The twisting/stranding of the sleeves averages out the strains on the sleeves, which allows the cable [100] to bend at a relatively low bend radius. In addition, twisting can limit micro-bending attenuation by providing the sleeves with a well-defined path.

The optical fiber cable [100] also contains at least one water swellable yarns [110] enclosed within the outer sheath [102] to prevent ingression of water or moisture within the cable. In yet another embodiment, the outer sheath encloses water swellable tape. Also, each sleeve [106] include a plurality of optical fibers [104].

Further, the optical fiber cable [100] includes at least one strength member [108] suspended linear to an axis of the optical fiber cable [100]. The strength members [108] are coated or surrounded with an anti-corrosion layer to prevent the formation of rust.

In an embodiment, the strength member [108] comprises a pair of steel wires stranded together to form the single strength member.

In an embodiment, more than one strength members are embedded in the outer sheath [102]. In a preferred embodiment, two strength members are embedded in the outer sheath in diametrically opposite position.

The optical fiber cable of the present invention has breaking strength between 1300 and 2000 N and a nominal outer diameter not larger than 7.0 mm.

I/We claim:

1. An optical fiber cable [100] comprising—
at least one substantially round, outer sheath [102];
a plurality of easily peelable sleeves [106], wherein each sleeve [106] encloses a plurality of optical fibers [104], wherein each optical fiber [104] has a nominal outer diameter between 160 to 215 um; and
at least two strength members [108] suspended linear to an axis of the optical fiber cable [100],
wherein the optical fiber cable [100] has breaking strength between 1300 and 2000 N.

2. The optical fiber cable [100] as claimed in claim 1, wherein each strength member [108] comprises at least two stranded steel wires.

3. The optical fiber cable [100] as claimed in claim 1, wherein strength members [108] are embedded within the outer sheath [102].

4. The optical fiber cable [100] as claimed in claim 2 wherein each steel wire of the at least two stranded steel wires has a diameter of 0.30+/−0.05 mm.

5. The optical fiber cable [100] as claimed in claim 1, wherein the optical fiber cable [100] has a nominal outer diameter not larger than 7.0 mm and a nominal weight of 36.0+/−10% Kg/Km.

6. The optical fiber cable [100] as claimed in claim 1, wherein each optical fiber [100] has a nominal cladding diameter between 80 to 100 um.

7. The optical fiber cable [100] as claimed in claim 1, wherein the optical fiber cable [100] has a fiber strain less than 0.67% at maximum environmental load.

8. The optical fiber cable [100] as claimed in claim 1, wherein the easily peelable sleeves [106] are made of a material having a hardness less than 60 Shore D.

9. The optical fiber cable [100] as claimed in claim 1, wherein the easily peelable sleeves [106] have a nominal thickness of 0.2 mm or less.

10. The optical fiber cable [100] as claimed in claim 1, wherein the optical fibers [104] are ring marked if a number of optical fibers [104] within each sleeve [106] are more than 12.
